(19) United States
(12) Patent Application Publication
(10) Pub. No.: US 2011/0270970 A1
(43) Pub. Date: Nov. 3, 2011

(54) NETWORK DEVICE TESTING SYSTEM AND METHOD

(75) Inventors: YU-LONG LIN, Shenzhen City (CN); HUA DONG, Shenzhen City (CN); YI-YONG XIE, Shenzhen City (CN); JIE-JUN TAN, Shenzhen City (CN)

(73) Assignees: HON HAI PRECISION INDUSTRY CO., LTD, Tu-Cheng (TW); HONG FU JIN PRECISION INDUSTRY (ShenZhen) Co., LTD., Shenzhen City (CN)

(21) Appl. No.: 13/043,465

(22) Filed: Mar. 9, 2011

(30) Foreign Application Priority Data
Apr. 29, 2010 (CN) 201010160058.4

(51) Int. Cl. G06F 15/173

(52) U.S. Cl. 709/224

(57) ABSTRACT

A testing method tests a network device using a testing system by determining whether the network device is turned on via a second port of the network device. When the network device is turned on, the testing system logs onto the network device via the second port. A network service application of the network device is implemented and an IP address of the network device is obtained. Accordingly, a network connection to the network device is established. The testing system implements additional service applications of the network device and tests features of additional applications via a first port of the network device.

### BACKGROUND

1. Technical Field

Embodiments of the present disclosure relate to device testing, and particularly to a network device testing system and method.

2. Description of Related Art

Network and other service applications are often installed in a network device such as a webcam, providing various features of the network device. The features provided can be tested only when the network service application is implemented and network communication of the device established. Considerable time may be required for such operations. Furthermore, data packets are repeatedly sent to the network device to confirm the device's operational status, which can increase network traffic.

### BRIEF DESCRIPTION OF THE DRAWINGS

FIG. 1 shows an application environment of one embodiment of a network device testing system as disclosed.

FIG. 2 is a block diagram of a test unit of the network device testing system of FIG. 1.

FIG. 3 is a flowchart of one embodiment of a network device testing method using a network device testing system such as, for example, that of FIG. 1.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

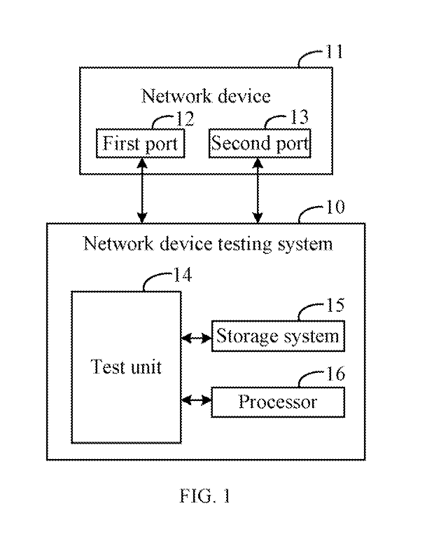

FIG. 1 shows an application environment of one embodiment of a network device testing system 10 as disclosed (hereinafter referred to as “the testing system 10”). The testing system 10 may reduce time and network traffic required to test a network device 11. The network device 11 is an electronic device, such as a webcam, for example used in a network. The network device 11 includes a first port 12 and a second port 13 connected to the testing system 10. The first port 12, such as a RJ45 port, is a network communication port for data transfer over a network. The second port 13, such as a RS-232 port or a universal serial bus (USB) port, is a non-network communication port for direct data transfer. A network service application and many other service applications are installed in the network device 11. The service applications provide particular features to the network device 11 such as network communication. Video and audio capturing features can be provided, and both require testing by the testing system 10.

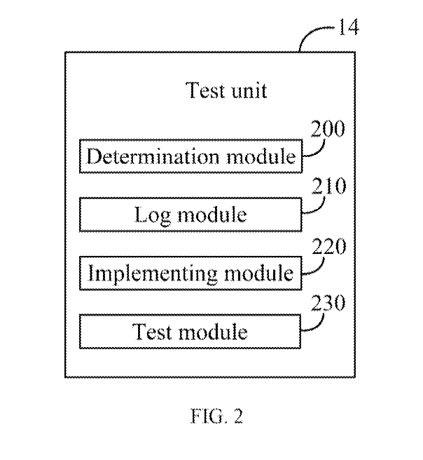

In one embodiment, the testing system 10 may include a test unit 14, a storage system 15, and at least one processor 16. The test unit 14 includes a number of function modules, as detailed in FIG. 2. The function modules may comprise computerized code in the form of one or more programs stored in the storage system 15. The computerized code includes instructions executed by the at least one processor 16 to provide functions for the modules. In one embodiment, the storage system 15 may be an internal storage device, such as a random access memory (RAM) for temporary storage of information, and/or a read only memory (ROM) for permanent storage of information. In some embodiments, the storage system 15 may also be an external storage device, such as an external hard disk, a storage card, or a data storage medium.

FIG. 2 is a block diagram of a test unit 14 of the network device testing system of FIG. 1, which may include a determination module 200, a login module 210, an implementing module 220, and a test module 230.

The determination module 200 determines whether the network device 11 is turned on via the second port 13. In one embodiment, the network device 11 transmits a ready message to the testing system 10 via the second port 13 at startup. The determination module 200 determines that the network device 11 is turned on upon receipt of the ready message from the second port 13.

The login module 210 logs onto the network device 11 via the second port 13 when the network device 11 is turned on, at which time the testing system 10 can access and control the network device 11. In one embodiment, a user name and a password are pre-registered in the network device 11. The login module 210 uses the user name and the password to log onto the network device 11.

The implementing module 220 implements the network service application and obtains an IP address of the network device 11. The network service application enables communication with the testing system 10 via the first port 12. In one embodiment, the implementing module 220 directs the network device 11 to send a data packet to the testing system 10 via the first port 12. The implementing module 220 obtains the IP address of the network device 11 from the received data packet.

The test module 230 establishes a network connection between the network device 11 and the testing system 10 according to the obtained IP address. The test module 230 also implements additional service applications and tests features of the network device 11 provided by the additional service applications via the first port 12. For example, the test module 230 can implement a video service application and an audio service application of a webcam, and test the video and audio capturing features thereof. In one embodiment, the network device includes test items unrelated to particular service applications, such as performance tests of processor and memory of the network device 11. The test module 230 may further test such test items without implementing any additional service applications.

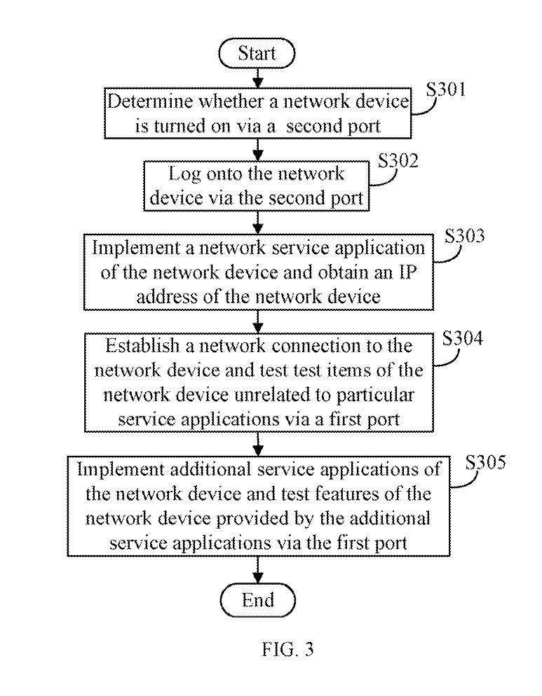

FIG. 3 is a flowchart of one embodiment of a network device testing method using a network device testing system such as, for example, that of FIG. 1. Depending on the embodiments, additional blocks may be added, others removed, and the ordering of the blocks may be changed.

In block S301, the determination module 200 determines whether the network device 11 is turned on via the second port 13 of the network device 11. The network device 11 is ready to be tested when the network device 11 is turned on.

In block S302, the login module 210 logs onto the network device 11 via the second port 13 when the network device 11 is turned on. In one embodiment, the login module 210 uses a pre-registered user name and password to log onto the network device 11.

In block S303, the implementing module 220 implements a network service application of the network device 11 and obtains an IP address of the network device 11. As described previously, the network service application provides network communication for the network device 11. The obtained IP address makes the network device 11 accessible via the first port 12.

In block S304, the test module 230 establishes a network connection between the network device 11 and the testing system 10 according to the obtained IP address, and tests test items of the network device 11 unrelated to particular service applications via the first port 12. When testing the test items unrelated to particular service applications, the test module 230 implements no particular service applications. For example, the test module 230 tests the processor and memory of the network device 11 directly.

In block S305, the test module 230 implements additional service applications of the network device 11, and tests features of the network device 11 provided by the additional service applications via the first port 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A testing system for testing a network device, the network device comprising a first port and a second port, the testing system comprising:
a storage system;
at least one processor;
one or more programs stored in the storage system and executable by the at least one processor, the one or more programs comprising:
a determination module operable to use the second port to determine whether the network device is turned on;
a login module operable to use the second port to log onto the network device when the network device is turned on;
an implementing module operable to implement a network service application of the network device and obtain an IP address of the network device; and
a test module operable to establish a network connection between the network device and the testing system according to the IP address of the network device, implement additional service applications of the network device, and use the first port to test features of the network device provided by the additional service applications.

2. The testing system of claim 1, wherein the second port is a RS-232 port or a USB port.

3. The testing system of claim 1, wherein the implementing module analyzes data packets received from the network device to obtain the IP address of the network device.

4. The testing system of claim 1, wherein the network device is a webcam.

5. The testing system of claim 1, wherein the first port is a network communication port, and the second port is a non-network communication port.

6. A testing method for testing a network device, the network device comprising a first port and a second port, the method comprising:
using the second port to determine whether the network device is turned on;
using the second port to log onto the network device when the network device is turned on;
implementing a network service application of the network device and obtain an IP address of the network device; and
establishing a network connection with the network device according to the IP address of the network device; and
implementing additional service applications of the network device and using the first port to test features of the network device provided by the additional service applications.

7. The method of claim 6, wherein the second port is a RS-232 port or a USB port.

8. The method of claim 6, wherein the IP address of the network device is obtained by analyzing data packets received from the network device.

9. The method of claim 6, wherein the network device is a webcam.

10. The method of claim 6, wherein the first port is a network communication port, and the second port is a non-network communication port.

11. A non-transitory storage medium having stored thereon instructions that, when executed by a processor of a computerized device, causes the computerized device to execute a testing method for testing a network device, the network device comprising a first port and a second port, the method comprising:
using the second port to determine whether the network device is turned on;
using the second port to log onto the network device when the network device is turned on;
implementing a network service application of the network device and obtain an IP address of the network device; and
establishing a network connection with the network device according to the IP address of the network device; and
implementing additional service applications of the network device and using the first port to test features of the network device provided by the additional service applications.

12. The medium of claim 11, wherein the second port is a RS-232 port or a USB port.

13. The medium of claim 11, wherein the IP address of the network device is obtained b analyzing data packets received from the network device.

14. The medium of claim 11, wherein the network device is a webcam.

15. The medium of claim 11, wherein the first port is a network communication port, and the second port is a non-network communication port.
